(19) United States
(12) Patent Application Publication
(10) Pub. No.: US 2016/0031292 A1
(43) Pub. Date: Feb. 4, 2016

(54) VEHICLE COOLING CONTROL SYSTEM

(71) Applicant: Ford Global Technologies, LLC, Dearborn, MI (US)

(72) Inventors: Mark G. SMITH, Canton, MI (US); Kenneth J. JACKSON, Dearborn, MI (US); Thomas Joseph CUSUMANO, Royal Oak, MI (US)

(21) Appl. No.: 14/446,496

(22) Filed: Jul. 30, 2014

(51) Int. Cl. B60H 1/32

(52) U.S. Cl. CPC B60H 1/3205

(57) ABSTRACT

A vehicle climate control system includes a condenser, a compressor, and a loop fluidly connecting the condenser and compressor. The system also includes a valve arrangement disposed within the loop. The valve arrangement includes a thermal expansion valve integrated with a solenoid valve. The solenoid valve has a powered closed state to prevent fluid flow into an evaporator and a non-powered open state to allow fluid flow through the thermal expansion valve into the evaporator. The evaporator is for cooling a cabin. The system further includes a controller programmed to, in response to a request for cooling of the cabin, command the solenoid valve from the powered state to the non-powered state.

### TECHNICAL FIELD

The present application relates to control systems for vehicle cooling arrangements.

### BACKGROUND

Many vehicles are equipped with heating, ventilation, and air conditioning (HVAC) systems that are utilized to heat or cool the cabin air of the vehicle to bring the cabin air temperature to a desired comfort level. The air conditioning system component of the HVAC system utilizes refrigerant that absorbs heat from air that is being introduced into the cabin and then rejects the heat to the ambient air.

### SUMMARY

A vehicle includes a climate control system. The climate control system includes a condenser, a compressor, and a loop fluidly connecting the condenser and compressor, and a normally open valve disposed therein. The vehicle further includes a controller programmed to, in response to a request for cabin cooling, cut power to the valve to open the valve to allow fluid to flow through the loop.

A method of controlling a climate control system for a vehicle includes, in response to a request for cooling a cabin of the vehicle, commanding a normally open valve disposed within a fluid loop of the climate control system to a non-powered state to allow fluid to flow through the loop to an evaporator of the climate control system configured to cool air for the cabin.

A vehicle climate control system includes a condenser, a compressor, and a loop fluidly connecting the condenser and compressor. The system also includes a valve arrangement disposed within the loop. The loop includes a thermal expansion valve integrated with a solenoid valve. The solenoid valve has a powered closed state to prevent fluid flow into an evaporator and a non-powered open state to allow fluid flow through the thermal expansion valve into the evaporator. The evaporator is for cooling a cabin. The system further includes a controller programmed to, in response to a request for cooling of the cabin, command the valve from the powered state to the non-powered state.

### BRIEF DESCRIPTION OF THE DRAWINGS

FIG. 1 is a schematic view of a vehicle;

FIG. 2 is a graph depicting operation of a vehicle cooling system;

FIG. 3 is a diagrammatic view of a vehicle fluid loop; and

FIG. 4 is a flow chart describing control logic for a vehicle cooling system.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

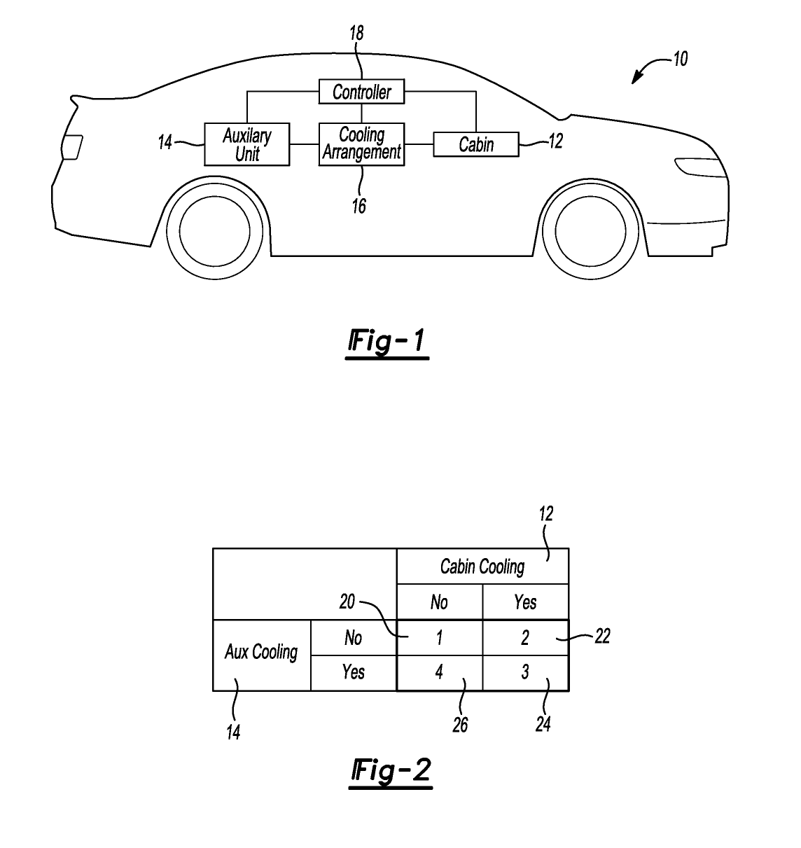

Referring to FIG. 1, a vehicle 10 having a cabin 12, an auxiliary unit 14, and a cooling arrangement 16 is illustrated. The cooling arrangement 16 includes a condenser, a compressor, and a loop fluidly connecting the condenser and compressor. The loop is arranged such that the refrigerant may flow through a thermal expansion valve with an integrated shut-off valve (hereinafter “TXV”) upon request for cabin cooling. While an integrated shut-off valve is preferred, a shut-off valve connected in series with the TXV may also be used. Further, the loop is arranged such that refrigerant may flow through an electronic expansion valve (hereinafter “EXV”) upon a request for cooling to the auxiliary unit 14. A controller 18 coordinates the flow of refrigerant through the fluid loop. The controller 18 is shown as one controller, but may include of one or several different system controllers.

The auxiliary unit 14 may include one of several vehicle systems, such as a traction battery, a traction motor, an inverter, power electronics, a transmission including the transmission electronics and/or the transmission fluid, a turbocharger, a supercharger, a fuel cell exhaust gas waster condenser, a device to cool diesel fuel, or a device to cool engine oil. This list is not meant to be exhaustive and it should be understood that the system could be utilized to cool any auxiliary unit that may require additional cooling.

Conserving power in an electric or hybrid vehicle 10 may be important. By conserving power, the auxiliary unit 14 is able to operate for longer periods, reducing the need to fuel an engine. This allows the vehicle 10 to operate using less fuel and thus improves the fuel economy of the vehicle 10. One way to conserve power is to optimize the cooling arrangement 16. For example, a typical TXV with an integrated 12 volt solenoid shut-off valve requires approximately 1 to 2 amps in order to open the solenoid valve, allowing refrigerant to flow through the TXV and into an evaporator core. By optimizing the control logic of the solenoid type TXV to reduce the times it needs to be powered, the vehicle may improve its fuel economy.

Conventionally, solenoid type TXVs are powered on when they are open. This allows for a powered state to relate to an open TXV position. When the TXV is in an open position, refrigerant freely flows into the evaporator. Likewise, the solenoid type TXV has a non-powered state relating to a closed TXV position. When the TXV is in a closed position, no refrigerant flows through it. This allows the vehicle climate control system to divert the flow of refrigerant to an additional fluid loop. In hybrid electric vehicles, the additional fluid loop is used to cool the vehicle auxiliary unit 14.

An EXV valve may be used instead of a TXV to control the flow of refrigerant used to cool the auxiliary unit 14. The EXV may be used as both a refrigerant expansion valve and as a shutoff valve. It may be powered by a stepper motor, such that the position is held constant when the motor stops turning. Therefore, it only takes power when the motor is moving. Because the EXV only takes power when the motor is moving, optimizing the TXV design and control logic may help conserve power.

Optimizing the logic of the TXV in order to conserve power while still maintaining a dual fluid loop control system is, in certain examples, an object of the present disclosure. The dual fluid loop control system may require independent operation of each evaporator core in the vehicle climate control system. Therefore, each line that allows refrigerant flow to each of the evaporator cores may, in order to avoid unintended cooling to the evaporator core, have a refrigerant flow shutoff feature.

Referring to FIG. 2, a chart depicting the independent operation of the TXV and the EXV is shown. The first quadrant, at 20, corresponds to a situation in which neither the cabin 12, nor the auxiliary unit 14 need cooling. The second quadrant, at 22, corresponds to a situation in which the cabin 12 requires cooling and the auxiliary unit 14 does not require cooling. The third quadrant, at 24, corresponds to the situation in which both the cabin 12 and the auxiliary unit 14 require cooling. The fourth quadrant, at 26, corresponds to a situation in which the cabin 12 does not require cooling; however the auxiliary unit 14 requires cooling.

Conventionally dual cabin evaporator core climate systems may only operate in quadrants 1, 2, and 3. The dual operation of the cabin evaporator core system and the auxiliary unit evaporator core system drives a need for dual refrigerant line shut-off valves; namely the TXV solenoid valve and the EXV. Using an integrated solenoid shut-off valve with a TXV in conjunction with an EXV allows for independent operation of the cabin evaporator core system and the auxiliary unit evaporator core system. This allows for operation in all four quadrants. Utilizing an independent dual operation climate control may require the use of the refrigerant line shut-off valves for each fluid loop. Independent dual operation of the valves may prevent unintended cooling associated with the cabin evaporator core system and the auxiliary evaporator core system. This is described in more detail below.

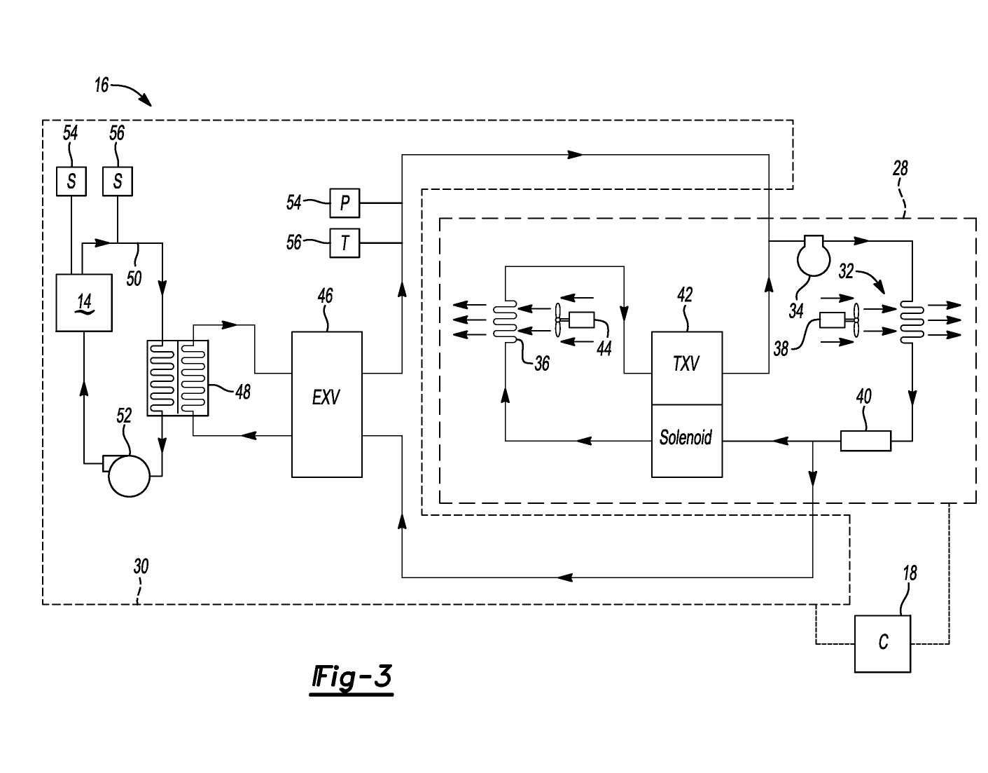

Referring to FIG. 3, the cooling arrangement 16 is illustrated. The cooling arrangement 16 includes a plurality of cooling loops 28, 30. Refrigerant is cycled through the cooling loops 28, 30. The refrigerant absorbs heat from the cooling loops 28, 30 and a condenser 32 rejects the heat to the ambient air. The cooling loop 28 includes a compressor 34. Low pressure, low temperature refrigerant, from an evaporator 36, flows into the compressor 34. Upon flowing out of the evaporator 36, the low pressure, low temperature refrigerant is a vapor, or superheated gas. The compressor 34 compresses the refrigerant into a high pressure, high temperature vapor. The high pressure, high temperature vapor refrigerant passes through the condenser 32.

The condenser 32 includes a fan 38. The fan 38 blows ambient air across the evaporator 36. This transfers heat from the refrigerant to the ambient air. After flowing through the condenser 32, the refrigerant is a high pressure, high temperature liquid. The refrigerant flows from the condenser 32 to a receiver-drier 40. The receiver-drier 40 serves as a filter and removes any excess moisture and contaminants within the cooling loops 28, 30. The receiver-drier 40 contains a desiccant that removes moisture from the refrigerant. The condenser 32 and receiver-drier 40 may be combined into a single unit.

The high pressure, high temperature liquid refrigerant flows from the receiver-drier to the TXV 42. The TXV 42 controls the flow rate of refrigerant entering the evaporator 36. The refrigerant flow rate through the TXV 42 depends on the refrigerant temperature after passing through the evaporator 36. If the temperature of the refrigerant leaving the evaporator 36 is above a threshold, the TXV 42 allows more liquid refrigerant to flow into the evaporator 36. If the temperature of the refrigerant leaving the evaporator 36 is below a threshold, the TXV 42 reduces the amount of refrigerant flowing into the evaporator 36. The TXV 42 restricts the flow of the refrigerant causing a pressure drop in the refrigerant.

The TXV 42 includes a needle valve that remains open during steady state operation. The size of the opening of the position of the needle is related to the pressure and temperature of the refrigerant exiting the evaporator 36. Two parts of the TXV 42 help to regulate the position of the needle: the thermo-head, which includes a diaphragm, and a spring. One side of the diaphragm is sealed and filled with refrigerant while the superheated refrigerant exiting the evaporator 36 flows past the opposite side of the diaphragm. A change in temperature of the superheated refrigerant creates a change in pressure on the diaphragm, controlling the opening and closing of the TXV 42. Since the pressure before the TXV 42 is higher than the pressure after the TXV 42, the refrigerant flows into the evaporator 36.

A spring within the TXV 42 further helps to regulate the position of the needle. The spring provides a continuous force on a valve stem biasing the needle in the closed position. The spring force constantly restricts the amount of refrigerant entering the evaporator 36. When the pressure of the sealed refrigerant acting on the diaphragm is greater than the pressure of the superheated refrigerant exiting the evaporator 36 combined with the force from the spring, the TXV 42 opens to increase the flow of the refrigerant. An increase of flow lowers the superheat of the refrigerant leaving the evaporator 36 and the process repeats until a balanced condition is attained.

Although a block type TXV 42 was described, other types of TXV 42 may be utilized. For example, a TXV 42 having a sensor bulb that remotely monitors the temperature change of the evaporator 36 may be used. Another example would be a pressure compensated TXV 42.

Refrigerant flows through the TXV 42 and into the evaporator 36. A fan 44 blows air across the evaporator 36 transferring heat from the air and into the refrigerant. The cooled air is blown into the vehicle cabin 12. The refrigerant leaving the evaporator 36 is a low pressure, low temperature superheated vapor that then flows through the TXV 42 on one side of the diaphragm, and again to the compressor 34, where the cycle repeats.

As stated above that the TXV 42 controls the flow rate of refrigerant into the evaporator 36. A solenoid type TXV 42 utilizes a solenoid valve connected in series or integrated with the TXV 42. The solenoid valve acts as a shut-off valve. For example, in the present disclosure the solenoid valve acts as a normally open valve. When the solenoid valve is in a powered state, the TXV 42 is closed. This prevents refrigerant from flowing through the TXV 42 and into the evaporator core 36. When the solenoid valve is in a non-powered state, refrigerant flows through the TXV 42 and into the evaporator core 36. The TXV 42 controls the flow rate of the refrigerant and the solenoid valve controls the on/off flow of refrigerant through the TXV 42.

Cooling loop 30, branches off cooling loop 28 just after the receiver-drier 40 and channels high pressure, high temperature liquid refrigerant to the EXV 46. The refrigerant exits the EXV 46 in a low pressure, low temperature liquid and vapor mixture, where it enters an auxiliary evaporator 48. Heat is transferred from the auxiliary unit 14 to the refrigerant in the auxiliary evaporator 48. The refrigerant exits the auxiliary evaporator 48 in a low pressure, low temperature superheated vapor state and passes through the EXV 46. The EXV 46 may operate as both a shut-off valve and as a refrigerant expansion valve. The refrigerant, still in the low pressure, low temperature superheated vapor state, is channeled back into the first cooling loop 28 and to the compressor 34. The EXV 46 may use pressure and temperature sensor data to control the flow of the refrigerant through the evaporator core.

The auxiliary unit 14 may have a coolant loop 50 which cycles a coolant, such as a glycol mixture, through the auxiliary unit 14 and the auxiliary evaporator 48. The coolant is cycled through the coolant loop 50 with a pump 52, and heat is transferred from the auxiliary unit 14 to the coolant and from the coolant to the refrigerant in the auxiliary evaporator 48. Coolant loop 50 may be a portion of a larger coolant loop.

The controller 18 receives pressure and temperature data from the auxiliary unit 14 and/or the coolant in the coolant loop 50. When the pressure or temperature of the auxiliary unit 14 and/or the coolant reaches a level where the auxiliary unit 14 requires cooling, the EXV 46 opens allowing refrigerant to flow through the second cooling loop 30. The pressure and temperature of the auxiliary unit 14 or the coolant in the cooling loop 50 may be detected by pressure and temperature sensors 54, 56. The pressure and temperature sensors 54, 56 may also be disposed on the cabin evaporator 36. The pressure and temperature sensors 54, 56 may be used by the controller 18 to determine whether the cabin evaporator 36 requires refrigerant to flow through the TXV 42. The pressure and temperature sensors 54, 56 may also be disposed inside the auxiliary unit battery pack, in the inlet coolant line, and in the outlet coolant line. The pressure and temperature sensors 54, 56 may also be used by the controller 18 to determine if refrigerant flow is needed in the auxiliary evaporator 48.

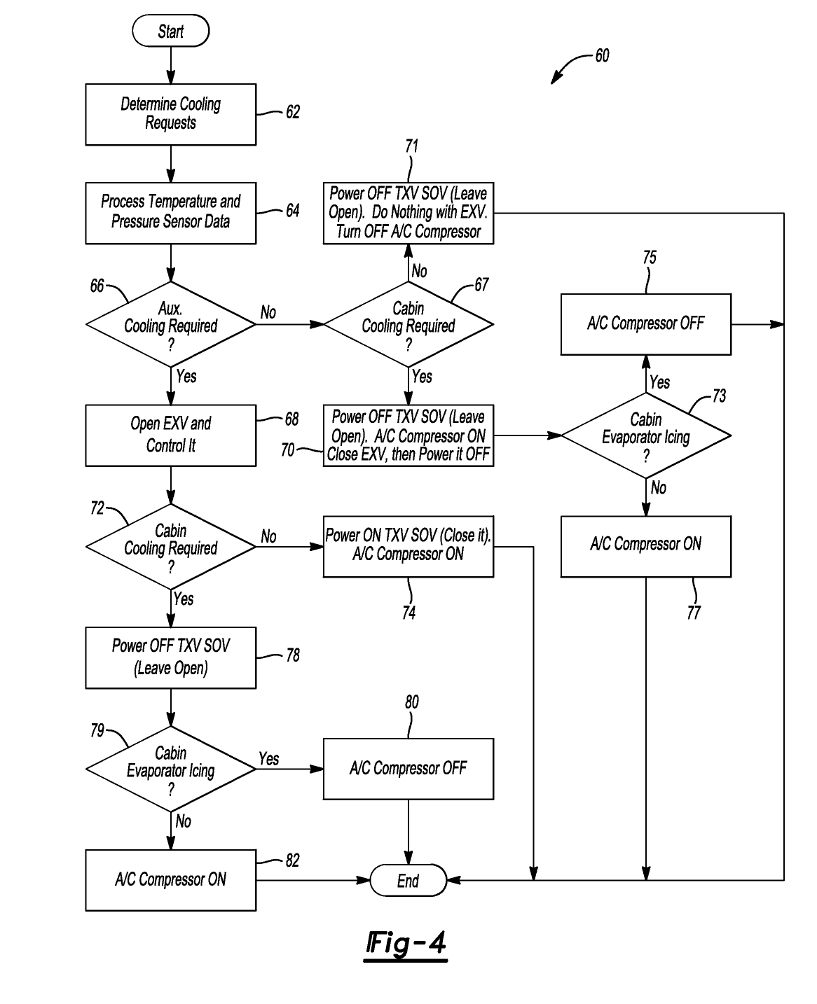

Referring to FIG. 4, control logic for the vehicle climate control system is described. The controller 60, at 62, determines cooling requests. At 62, the controller 60 determines if either a vehicle driver or vehicle passenger has demanded air-conditioning to the vehicle cabin. Further, the controller 60 will consider, at 62, demands for refrigerant to the auxiliary evaporator. Once a demand, at 62, for cooling is received by the controller 60, the controller 60 may process temperature and pressure data received from a temperature sensor or a pressure sensor, at 64.

The temperature and pressure data, at 64, allows the controller 60 to determine whether refrigerant is needed to either the cabin evaporator or the auxiliary evaporator. For example, the temperature or pressure data, at 64, received from the temperature sensors or the pressure sensors may instruct the controller 60 as to the temperature or the pressure of the battery cells and coolant. This allows the controller 60 to monitor the temperature and pressure of the battery cells and coolant, and optimize the flow of the refrigerant through the EXV. This optimizes cooling of the auxiliary evaporator through the use of a pressure transducer and the temperature sensors.

At 66, the controller 60 determines, from the temperature and pressure data received as well as from the cooling requests at 64 and 62, if the auxiliary evaporator requires cooling. If the controller 60, at 66, determines that the auxiliary evaporator requires cooling, then the controller 60, at 68, powers and controls the EXV. Powering the EXV, at 68, allows refrigerant to flow through the EXV and into the auxiliary evaporator. This allows the auxiliary evaporator to cool the auxiliary unit. As stated above, the EXV may be powered by a stepper motor. The stepper motor requires power only to move the valve and does not take power, other than for operation of the stepper motor control module. This allows the EXV to take very little power upon a cooling request.

If the controller 60 determines at 66 that the auxiliary evaporator does not require cooling, it determines at 67 if the cabin requires cooling. If the cabin requires cooling, at 67, the EXV may close, and the TXV solenoid valve may be powered off at 70. The TXV may be open when powered off. If no cabin cooling is required at 67, the TXV may remain powered off, and the EXV may be left in its current state at 71. Therefore, since the TXV is open in a non-powered state, a compressor, controlling the air conditioning of the cabin, may be turned off.

For example, the controller 60 may determine, at 73, if the cabin evaporator is icing. If the controller 60 decides the cabin evaporator is icing at 73, the controller 60 may command the compressor off at 75. Likewise, if the controller 60 determines, at 73, that the cabin evaporator is not icing, then the controller 60 may command the compressor on at 77.

At 72, the controller 60 determines whether the cabin evaporator requires cooling. If the cabin evaporator, at 72, does not require cooling, the controller 60 may command the TXV solenoid valve to power on. Powering on the TXV solenoid valve at 74 places the TXV in a closed position. When the valve is in a closed position, no refrigerant may flow through the TXV. Therefore, the TXV may only use power when the valve is closed. If the cabin evaporator at 72 requires cooling, and the auxiliary evaporator requires cooling at 66, the controller 60 may command the solenoid valve to power off at 78. Powering off the solenoid valve at 78 places the TXV in an open position. Therefore, the TXV may not need power when the cabin evaporator requires cooling, or when the cabin demands air conditioning.

For example, if the cabin evaporator and auxiliary evaporator do not require cooling at 66, 67, then the solenoid TXV and the EXV may not use power at 71. If the auxiliary evaporator requires cooling at 66, and the cabin evaporator does not require cooling at 72, the valves act differently. In this case, the EXV may take power at 68 and the solenoid TXV may take power to close the valve. This allows cooling to the auxiliary evaporator while preventing unintended cooling to the cabin evaporator.

If the controller 60 determines that the cabin evaporator does require refrigerant flow through the TXV at 72, the controller 60 may set the TXV to a default arrangement at 78. The default arrangement at 78 of the TXV is to be in a non-powered state. For example, the default arrangement at 78 would be to cut off power to the solenoid valve. The non-powered state of the TXV results in powering off the solenoid valve TXV. In this default arrangement, the TXV may operate as a normally open valve. In a normally open valve, when power is cut, the valve is open. This allows refrigerant to flow through the TXV and into the cabin evaporator. Therefore, the default arrangement at 78 of the TXV results in a non-powered state and an open position.

If the controller 60 determines that the cabin evaporator does not require refrigerant flow through the TXV at 72, the controller may set the TXV to an ancillary arrangement at 74. The ancillary arrangement at 74 of the TXV is to be in a powered state. For example, the ancillary arrangement at 74 would be to provide power to the solenoid valve. The powered state of the TXV results in powering the solenoid valve. In this ancillary arrangement at 74, the TXV may operate as a normally open valve. In a normally open valve, when power is provided to the solenoid valve, the valve is closed. This prevents refrigerant from flowing into the cabin evaporator. Therefore the ancillary arrangement at 74 of the TXV results in a powered state and a closed position.

Further, if the controller 60 determines the cabin requires cooling at 72 and powers off the TXV at 78, the controller 60 may determine if the cabin evaporator is icing at 79. If the controller 60 determines the cabin evaporator is icing at 79, then the controller 60 may command the compressor off at 80. If the controller 60 determines the cabin evaporator is not icing at 79, the controller 60 may command the compressor on at 82.

Using a TXV and a solenoid valve acting as a normally open valve within the fluid loop may help to improve hybrid electric vehicle performance. Allowing the TXV to remain in the open position in a non-powered state reduces the power necessary to operate the TXV. Reducing the amount of power needed to cool the vehicle cabin as well as the vehicle battery allows the hybrid electric vehicle to use a charge in the battery for other vehicle operations. This may improve overall fuel economy and efficiency of the battery.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a climate control system including, a condenser, a compressor, and a loop fluidly connecting the condenser and compressor, and having a normally open valve disposed therein; and
a controller programmed to, in response to a request for cabin cooling, cut power to the valve to open the valve to allow fluid to flow through the loop.

2. The vehicle of claim 1, wherein the normally open valve is a solenoid valve, further comprising a thermal expansion valve arranged within the loop and integrated with the solenoid valve, wherein the thermal expansion valve is configured to control a rate of fluid flow through the loop when the solenoid valve is off.

3. The vehicle of claim 1, wherein the normally open valve is a solenoid valve, further comprising a thermal expansion valve arranged within the loop in series with the solenoid valve, wherein the thermal expansion valve is configured to control a rate of fluid flow through the loop when the solenoid valve is off.

4. The vehicle of claim 1, wherein the controller is further programmed to, in response to temperature data from a temperature sensor being less than a threshold, cut power to the compressor.

5. The vehicle of claim 4, wherein the temperature sensor is configured to measure a temperature of a cabin evaporator of the climate control system.

6. The vehicle of claim 1, wherein the controller is further programmed to, in response to pressure data from a pressure sensor being less than a threshold, cut power to the compressor.

7. The vehicle of claim 6, wherein the pressure sensor is configured to measure a pressure of a cabin evaporator of the climate control system.

8. A method of controlling a climate control system for a vehicle comprising:
in response to a request for cooling a cabin of the vehicle, commanding a normally open valve disposed within a fluid loop of the climate control system to a non-powered state to allow fluid to flow through the loop to an evaporator of the climate control system configured to cool air for the cabin.

9. The method of claim 8, further comprising commanding the normally open valve to a powered state to prevent fluid flow through the loop.

10. The method of claim 8, further comprising in response to a request for cooling an auxiliary unit of the vehicle, commanding an electronic expansion valve disposed within the fluid loop of the climate control system to open to allow fluid to flow through the loop to an evaporator of the climate control system configured to cool a fluid mixture for the auxiliary unit.

11. The method of claim 10, wherein the electronic expansion valve is opened by a motor.

12. The method of claim 10, further comprising in response to a temperature signal from a temperature sensor disposed within the loop being less than a threshold, commanding the electronic expansion valve to close.

13. The method of claim 10, further comprising in response to a pressure signal from a pressure sensor disposed within the loop being less a threshold, commanding a compressor to power off.

14. A vehicle climate control system comprising:
a condenser, a compressor, and a loop fluidly connecting the condenser and compressor;
a valve arrangement disposed within the loop and including a thermal expansion valve integrated with a solenoid valve, the solenoid valve having a powered closed state to prevent fluid flow into an evaporator and a non-powered open state to allow fluid flow through the thermal expansion valve into the evaporator, wherein the evaporator is for cooling a cabin; and
a controller programmed to, in response to a request for cooling of the cabin, command the solenoid valve from the powered state to the non-powered state.

15. The vehicle climate control system of claim 14, wherein the solenoid valve is a normally open valve.

16. The vehicle climate control system of claim 14, further comprising a second valve configured to allow fluid to flow into a second evaporator.

17. The vehicle climate control system of claim 16, wherein the second valve is a thermal expansion valve.

18. The vehicle climate control system of claim 16, wherein the second valve is a stepper motor controlled throttling valve.

19. The vehicle climate control system of claim 16, wherein the controller is further configured to close the second valve upon receiving a temperature signal less than a threshold from a temperature sensor disposed within the loop.

20. The vehicle climate control system of claim 16, wherein the controller is further configured to command the compressor to power off upon receiving a pressure signal from a pressure sensor disposed within the loop less than a threshold.
